(19) United States
(12) Patent Application Publication
(10) Pub. No.: US 2012/0187630 A1
(43) Pub. Date: Jul. 26, 2012

(54) SHOOTING TARGET APPARATUS AND METHOD

(76) Inventor: Steve T. Barzee, University City, MO (US)

(21) Appl. No.: 13/343,409

(22) Filed: Jan. 4, 2012

Related U.S. Application Data
(60) Provisional application No. 61/429,619, filed on Jan. 4, 2011.

(51) Int. Cl. F41J 1/00; B29C 67/24

(52) U.S. Cl. 273/348; 264/239

(57) ABSTRACT

The present invention is a shooting target achieving biodegradability comprised of sodium bentonite and dextrin.

### CROSS-REFERENCE TO RELATED APPLICATIONS

This application claims priority to U.S. Provisional Patent application No. 61/429,619 filed Jan. 4, 2011.

### BACKGROUND OF THE INVENTION

1. Field of the Invention

The field of this invention is in targets for shooting sports, especially targets traditionally made out of clay, such as clay pigeons, rabbits, “minis” and “midis”.

2. Background

Shooting sportsmen have a long tradition of resource management, including the management of wild-life and habitat. These concerns have extended beyond the husbandry of flora and fauna and into concern for the deposition of materials in the environment. For example, environmentally toxic lead shot for shotguns has been largely replaced by non-toxic shot made of other metals. Another material that is frequently deposited in the environment through the activities of shooting sportsmen is the material from which shooting targets are made, such as for example “clay pigeons.” Both at shooting ranges and for private land owners, clay pigeons that have been thrown and/or shot fall to the ground where they are left or, if removed, are problematic to pick up.

The presence of the remnants of shooting targets on private land or shooting ranges is not trivial. Traditional targets are press molded composites of poly vinyl acetate and petroleum based binders such as tar. Such targets once deposited on the ground, usually in pieces or as powder (depending on the skill of the marksman who has been shooting at them) remain on the ground for six, seven or more years. The materials form which they are made is toxic and can be lethal to domestic or wild life that eats it. The remains of targets are often unsightly, as they are frequently painted day glow orange.

In response, certain products have been marketed as “biodegradable”. These so-called biodegradable targets, however, still take three, four or more years to degrade. While they may be less toxic than traditional target material, they still contain polyvinyl acetate and other binders, as for example, formaldehyde and/or urethanes.

In the meantime, consumer preferences and shooting regulations constrain the possible compositions for shooting targets. Frangibility is required, while maintaining a coherence sufficient for transportation, distribution and, ultimately, being thrown from mechanical throwing devices without breaking. Shooting regulations require sufficient frangibility that, when hit, the target must show visible separation of at least one piece. Preferably, a direct hit from a shotgun will result in the target turning to powder or dust.

Previous attempts to generate more “biodegradable” targets have required disadvantageous premolding of preconfigured break points in the target in order to achieve the required frangibility.

### SUMMARY OF THE INVENTION

The present invention is a shooting target, for example a “clay pigeon”, with markedly improved biodegradability over the state of the art and frangibility comparable with non-biodegradable traditional targets. The present invention is a composition comprising sodium bentonite and refined vegetable starches, such as polymerized starches, for example, dextrin.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a side view of a shooting target, as configured for trap and skeet shooting.

FIG. 2 is a top view of a shooting target.

### DETAILED DESCRIPTION

Surprisingly, sodium bentonite bound with dextrin may be formed according to the present invention into shooting targets that are biodegradable and frangible. Sodium bentonite, a form of clay, and dextrin, a refined vegetable starch, are both naturally occurring in unrefined forms and accordingly are biodegradable. When prepared as described herein, and molded into a shooting target, they retain sufficient coherence for transportation and launching as an aerial target while remaining adequately frangible.

A shooting target, according to the present invention, is composed of about 3% to about 7% dextrin, preferably between 5% and 6% dextrin. The balance of the composition of the target would be sodium bentonite, and/or sodium bentonite combined with a volume material such as silica.

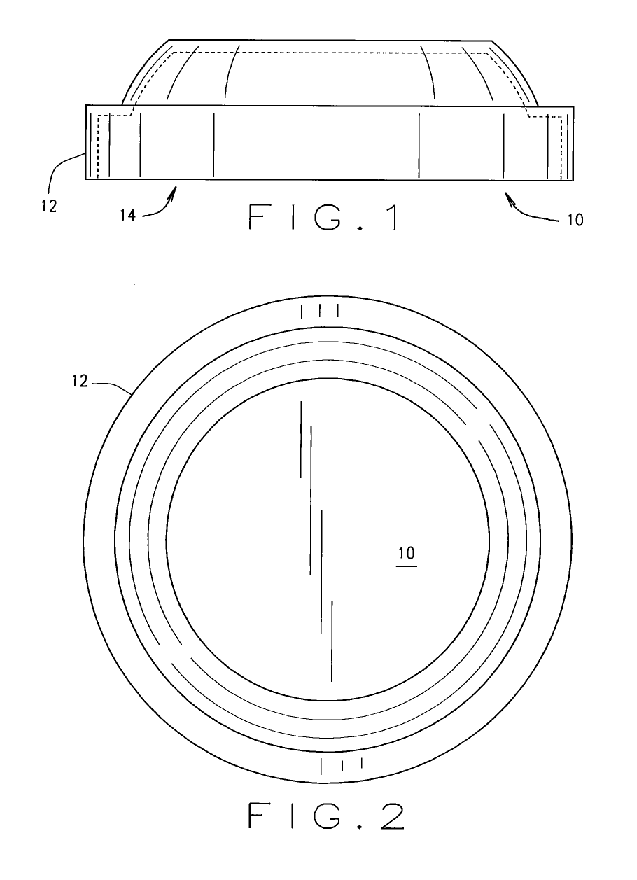

The process for making shooting targets according to the present invention will be described for a standard aerial target of 105 grams (shooting competition regulations require a target weighing between 95 and 105 grams and having an outside diameter of 4 5/16 inches with a rim height of 1⅛ inch). FIGS. 1 and 2 depict such a target 10, having a rim 12 and a concavity 14. Any material from which a target is made must be moldable into a shape similar to that depicted and thereafter shipped and thrown in that configuration.

In a first example, 103 grams of sodium bentonite by weight are mixed with 6 grams of dextrin by weight. Sodium bentonite powder of 20 micron grade is used. After thorough mixing with pressure and not mixing by mere tumbling, 40 grams of water by weight or a volume less than about 100 cubic centimeters is added to create a particulate paste. Mixing is continued until the bulk of the volume of the material is congealed and self adherent, usually as a single mass.

The resulting composition may then be placed in a mold for a single standard shooting target. The mold may be made out of aluminum alloy or a coated material to avoid oxidation. The interior of the mold may be treated periodically with wax silicon or other like release material, as the dextrin composition is adherent. The mold is closed and put under pressure. According to the method of the present invention between about 300 pounds per square inch up to about 900 pounds per square inch may be used, with about 300 to about 700 psi being preferable, particularly for a single or a small number of targets being molded, with between about 400 and about 600 psi being most preferable. Temperature is increased to greater than 212 degrees for elimination of the water in the composition material. The temperature range is preferably beneath about 400 degrees and most preferably between about 300 and about 350 degrees Fahrenheit. Molding time is typically between about one and about two minutes. Increases in pressure and/or temperature may reduce molding time. Under appropriate conditions, molding time is as short as about 20 seconds, within the scope of the present invention.

The materials from which the present invention is composed are non-toxic. Sodium bentonite is a common basic component in cosmetics. Dextrin is frequently used as a binder for food products.

The degradability of the composition of the present invention is demonstrable. A shooting target prepared as disclosed herein when placed in a container of water will dissolve in a matter of hours. By contrast, prior art shooting targets marketed as “biodegradable”, when put in water, failed to dissolve even after a period of months.

A clay pigeon prepared according to the method of the present invention is sufficiently frangible to be molded without preconfigured break points.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A shooting target as disclosed herein.

2. A method of producing a shooting target as disclosed herein.

3. A shooting target comprised of about 3% to about 7% dextrin and the balance sodium bentonite.

4. A method of producing a shooting target comprising:
mixing sodium bentonite powder in a volume comprising about 93 to about 97% of a total volume with a volume of dextrin comprising about 3% to about 7% of a total mixed volume:
Adding to said mixture of sodium bentonite and dextrin a volume of water comprising between about 20% and about 30% of a new combined volume;
Molding said composition under a pressure of from about 300 psi to about 900 psi and a temperature from about 212 degrees to about 400 degrees Fahrenheit for a time from about 20 seconds to about 2 minutes.
